(19) United States
(12) Patent Application Publication
(10) Pub. No.: US 2016/0213015 A1
(43) Pub. Date: Jul. 28, 2016

(54) FOODSTUFFS PREPARATION (I)

(71) Applicant: DMK Deutsches Milchkontor GmbH, Zeven (DE)

(72) Inventors: Marina Schomacker, Sittensen (DE); Michael Hahn, Heerlingen (DE)

(21) Appl. No.: 15/005,457

(22) Filed: Jan. 25, 2016

(30) Foreign Application Priority Data
Jan. 27, 2015 (EP) 15 152 760

(51) Int. Cl. A23C 19/076; B65B 3/26; B65D 77/08

(52) U.S. Cl. CPC A23C 19/076; B65D 77/08; B65B 3/26

(57) ABSTRACT

A spreadable foodstuffs preparation is proposed comprising
(a) a fresh cheese component and
(b) a fruit preparation,
   wherein the components (a) and (b) are present side by side in a container such that they occupy three-dimensionally continuous volumes that do not mix.

### FIELD OF THE INVENTION

The invention resides in the field of dairy products and relates to a spreadable foodstuffs preparation based on fresh cheese and fruit.

### PRIOR ART

Fresh cheese and fruit preparations, especially regular quark and jam, are by far the most popular spreads, especially in European Union countries. Use of these products together is particularly popular, this generally comprising initially spreading the fresh cheese and then applying the fruit preparation thereupon. This has hitherto required two different products that are spread individually, thus also necessitating an application means for each of the products, i.e. a knife or a spoon, to prevent contamination of the individual products.

In the present age of so-called “convenience products” it is a typical consumer requirement for everything to be made simpler even in the foodstuffs sector. Why purchase two products when they are to be used together anyway? In the present case two approaches have hitherto been taken in this regard, namely a product where the two components are spatially separate, and a mixed product of fresh cheese and fruit preparation. To date, the 2-in-1 products have not become established in the market since, ultimately, no progress has been achieved when both components need to be applied to the bread one after another. The mixed product meets neither the aesthetic requirements nor the taste requirements of the market.

EP1348340 B1 (NESTLE) discloses a dairy product preparation which may likewise comprise a fruit base as a second component. The products are produced by coextrusion, the components then each being arranged in individual sectors not in contact with one another. This again only allows for spreading either one component or the other.

It is accordingly an object of the present invention to provide a spreadable preparation comprising both fresh cheese and a fruit mix where the two components may be removed from a container/vessel and employed as a spread together with no mixing taking place in the container so that both components are also perceived as separate constituents.

It is a further object of the invention to preferably select the components such that said components do not adversely affect one another in terms of their sensory properties. This includes in particular a change in the consistency of the fresh cheese component due to reaction with fruit acids and a change in taste due to pervasion of the product with a fruit taste typical of the art which may issue from the fruit preparation.

### DESCRIPTION OF THE INVENTION

The invention provides a spreadable foodstuffs preparation comprising

(a) a fresh cheese component and
(b) a fruit preparation,
wherein the components (a) and (b) are present side by side in a container such that they occupy three-dimensionally continuous volumes that do not mix.

It has now been found that, surprisingly, the object of the invention is comprehensively achieved by ensuring that both components are filled into the containers/vessels such that said components form continuous volumes, i.e. are present side by side as separate components.

The components (a) and (b) may form respective three-dimensionally continuous volumes by

being layered;

forming a swirl pattern,

being present as respective separate strands

in the container.

It has proven to be particularly advantageous when the components either form a swirl pattern or are present as separate strands. A swirl pattern is to be understood as meaning that the components span a spiral-shaped pattern which extends uninterruptedly in the plane and in the depth of the container. The strand pattern corresponds to the pattern known from other foodstuffs packaged in tubes and likewise comprising two components having different colors or tastes.

The present invention accordingly also encompasses a spreadable foodstuffs preparation comprising

(a) a fresh cheese component and
(b) a fruit preparation
obtainable by filling the two components into a vessel using suitable processes more particularly described hereinbelow such that said components either form a swirl pattern or are present as respective separate strands.

Container

In the context of the invention a container is to be understood as meaning any vessel suitable in terms of its shape and material for receiving foodstuffs, especially creamy products as represented by the preparations according to the invention, in order that said foodstuffs may be delivered to the end user. Although this is not critical to the invention, the containers are generally bowls or pots of between 50 and 500 ml in volume, preferably between 100 and 250 ml in volume, which after filling, are closured with a foil/film/lidding and optionally a lid and then packaged in trays/pallets and delivered to the trade. The vessels may be opaque but are preferably transparent in order that the consumer may perceive the attractive pattern, be it the layering, the swirl or the strands.

Fresh Cheese

The term fresh cheese is understood by those skilled in the art to mean cheese varieties produced from pasteurized milk which, in contrast to many other cheese types, require only very little maturation, if any, and are immediately ready for consumption. In Germany, the German regulations on cheese Käseverordnung stipulate that said varieties must have a water content in the nonfatty matter of more than 73 percent. Fresh cheese accordingly has only a short shelf life and must be refrigerated during storage as much as possible. In contrast to other cheese varieties, preparation of fresh cheese requires less rennet, a lower denaturation temperature and a longer denaturation time. Fresh cheese of any fat content is available. Fresh cheese varieties include for example bryndza, Brousse du Rove, burrata, farmer's cheese (also known as cottage cheese which is produced from low-fat milk but in some cases contains added cream), mascarpone, panir, quark, cream cheeses of all fat contents, ricotta and layer cheeses and also ziger cheese.

It is preferable when the preparations according to the invention comprise regular quark as component (a). Producing quark generally comprises subjecting skimmed milk to heat treatment and denaturing the proteins present. Subsequent addition of lactic acid bacteria and rennet brings about so-called coagulation (phase inversion) of the milk. The casein coagulates and forms what is referred to in the art as coagulum. After ripening (8 to 20 h) the coagulum is agitated. This initiates whey separation and the two phases are then separated in the separator. The liquid acid whey is processed by other means and the quark base mix is adjusted to the desired fat and protein content by adding cream.

A further preferred embodiment of the invention employs a specific quark base mix (i.e. a quark which has not yet had any cream added to it) obtainable by

a) subjecting the raw milk to heat treatment and removing the cream to obtain an unacidified quark base mix,
b) subjecting the thus obtained mixture to heat treatment until onset of denaturation,
c) admixing the denatured product with starter cultures and rennet and optionally
d) adjusting the quark base mix obtained after completion of fermentation to a defined dry matter content and protein content,
where the starter cultures employed are
(i) a first mixture of five microorganism strains comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris and
(ii) a second mixture of three microorganism strains comprising (ii-1) Streptococcus thermophilus, (ii-2) Lactococcus lactis subsp. lactis and (ii-3) Lactococcus lactis subsp. cremoris.

Such quark base mixes preferably have a Brookfield viscosity (RVT, spindle 1, 10 RPM) at 20° C. in the range from about 1000 to about 8000 mPas, preferably about 2000 to about 6000 mPas and in particular about 3000 to about 5000 mPas.

The advantage associated with using such quark base mixes is that the use of the selected starter cultures affords a quark with a significantly improved taste which tastes creamy and does not leave a slimy overall impression. The mix moreover has a consistency which markedly retards whey issuance after removal from the container/vessel although it does not prevent such issuance completely. The invention ensures that the final product retains its appetizing appearance even after repeated product removal.

The advantageous consistency may be yet further improved by subjecting the quark mixes to an aftertreatment by introducing a defined amount of shear energy via at least one rotor-stator mixer; this process is also known as “stretching”. This employs one- to three-stage systems as required. Varying slot width, number and geometry of tooth rows, number of rotor-stator sets, residence time and speed of rotation makes it possible to achieve the viscosity and creaminess desired in each case, those skilled in the art being able to adjust these parameters based on their general knowledge without having to exercise inventive skill. Appropriate units are commercially available from, for example, Ytron Process Technology GmbH under the trade name “Ytron-Z” (Ytron mixers).

The fresh cheese base mix obtained after fermentation and optionally after stretching is then adjusted to the desired content of dry matter, proteins and fat, for example by adding cream. The dry matter content is preferably about 15 to about 24 wt % and in particular about 18 wt %. The protein content may be about 10 to about 15 wt % and preferably about 12 wt %.

Fruit Preparation

The nature of the fruit preparations is of little importance in the context of the invention and is essentially determined by taste specifications. Component (b) may thus be, for example, jam, fruit spread, confiture or fruit jelly.

Jam is to be understood as meaning the traditional term for a spread produced from fruit stewed with sugar where no fruit pieces remain visible in the end product.

By contrast, a confiture is to be understood as meaning a product in which the fruit pieces remain visible.

Fruit jellies comprise pectin which is present in many fruits, in particular in apples. To release said pectin from the cell walls, pectin-rich fruits are stewed with sugar. The sugar draws water out of the cells thus destroying their walls and allowing the pectin to be released more easily. Provided there is enough sugar present in the solution the water being released binds to the sugar—the pectin molecules can only react with one another and can no longer react with the water. However, in order for said molecules to connect to form a scaffold in which the water is “trapped” during cooling, they must be present in sufficient concentration and the solution must be acidic since the pectin molecules otherwise repel one another (due to ionization). pH 3.3 is ideal. In accordance with food law, jellies made of aqueous fruit extracts or concentrated fruit juice are referred to as jelly (fruit juice content of at least 35%) or extra jelly (fruit juice content of at least 45%).

Preparations

The preparations according to the invention may comprise the components (a) and (b) in a weight ratio of about 80:20 to about 50:50 and preferably of about 70:30 to about 60:40.

In addition to the two components (a) and (b) the preparations may also comprise further auxiliary/added substances including in particular thickeners and acidulants and also acidity regulators.

In a preferred embodiment the preparations according to the invention may therefore accordingly comprise the components in the following amounts:

(a) about 20 to about 80 wt %, preferably about 50 to about 60 wt %, of fresh cheese,
(b) about 20 to about 50 wt %, preferably about 30 to about 40 wt %, of fruit preparation,
(c) 0 to about 5 wt %, preferably about 1 to about 3 wt %, of thickeners,
(d) 0 to about 2 wt %, preferably about 0.5 to about 2 wt %, of acidulants and acidity regulators, and
(e) 0 to about 3 wt %, preferably about 1 to about 2 wt %, of further auxiliary/added substances
with the proviso that the specified amounts sum to 100 wt %.

Thickeners

Thickeners, i.e. optional component (c), are substances whose primary function is to bind water. Removal of unbound water brings about an increase in viscosity. Above a concentration characteristic for each thickener this effect is augmented by network effects which result in an increase in viscosity which is generally disproportional. In this case molecules are said to “communicate” with one another, i.e. become entangled. Most thickeners are linear or branched macromolecules (for example polysaccharides or proteins) which can interact with one another via intermolecular interactions, such as hydrogen bridges, hydrophobic interactions or ionic relationships. Extreme cases of thickeners are sheet silicates (bentonites, hectorites) or hydrated SiO₂ particles in the form of dispersed particles which can bind water in their solid-state-like structure or, on account of the described interactions, interact with one another. Examples include:
E 400—alginic acid
E 401—sodium alginate
E 402—potassium alginate
E 403—ammonium alginate
E 404—calcium alginate
E 405—propylene glycol alginate
E 406—agar agar
E 407—carrageenan, furcelleran
E 407—carob bean meal
E 412—guar kernel meal
E 413—tragacanth
E 414—gum arabic
E 415—xanthan
E 416—karaya (Indian tragacanth)
E 417—tara gum meal (Peruvian carob bean meal)
E 418—gellan
E 440—pectin, Opekta
E 440ii—amidated pectin
E 460—microcrystalline cellulose, cellulose powder
E 461—methylcellulose
E 462—ethylcellulose
E 463—hydroxypropylcellulose
E 465—methylethylcellulose
E 466—carboxymethylcellulose, sodium carboxymethylcellulose

Acidulants

The foodstuffs may comprise acidulants and/or acidity regulators. Acids in the context of the invention are preferably acids approved for use in foodstuffs, in particular:
E 260—acetic acid
E 270—lactic acid
E 290—carbon dioxide
E 296—malic acid
E 297—fumaric acid
E 330—citric acid
E 331—sodium citrate
E 332—potassium citrate
E 333—calcium citrate
E 334—tartaric acid
E 335—sodium tartrate
E 336—potassium tartrate
E 337—sodium potassium tartrate
E 338—phosphoric acid
E 353—metatartaric acid
E 354—calcium tartrate
E 355—adipic acid
E 363—succinic acid
E 380—triammonium citrate
E 513—sulphuric acid
E 574—gluconic acid
E 575—glucono delta-lactone

Acidity Regulators

Acidity regulators are food additives which keep acidity or basicity, and thus the desired pH of a foodstuff, constant. These are generally organic acids and salts and carbonates thereof and more rarely inorganic acids and salts thereof. The addition of an acidity regulator may enhance the stability and firmness of the foodstuff, bring about a desired precipitation and improve the action of preservatives. In contrast to acidulants, said regulators are not used to alter the taste of foodstuffs. Their action is based on the formation of a buffer system in the foodstuff where addition of acidic or basic substances results in only a small change in pH, if any. Examples include:
E 170—calcium carbonate
E 260-263—acetic acid and acetates
E 270—lactic acid
E 296—malic acid
E 297—fumaric acid
E 325-327—lactates (lactic acid)
E 330-333—citric acid and citrates
E 334-337—tartaric acid and tartrates
E 339-341—orthophosphates
E 350-352—malates (malic acid)
E 450-452—di-, tri- and polyphosphates
E 500-504—carbonates (carbon dioxide)
E 507—hydrochloric acid and chlorides
E 513-517—sulphuric acid and sulphates
E 524-528—hydroxides
E 529-530—oxides
E 355-357—adipic acid and adipates
E 574-578—gluconic acid and gluconates

Further Auxiliary/Added Substances

Sweeteners.

The further auxiliary/added substances that may be present in the preparations include, for example, sweeteners. Useful Sweeteners or sweet-tasting added substances include in the first instance carbohydrates and especially sugars, for instance sucrose/saccharose, trehalose, lactose, maltose, melizitose, raffinose, palatinose, lactulose, D-fructose, D-glucose, D-galactose, L-rhamnose, D-sorbose, D-mannose, D-tagatose, D-arabinose, L-arabinose, D-ribose, D-glyceraldehyde and maltodextrin. Likewise useful are plant preparations containing these substances, for example based on sugar beets (Beta vulgaris ssp., sugar fractions, sugar syrup, molasses), sugar cane (Saccharum officinarum ssp., molasses, sugar cane syrup), maple syrup (Acer ssp.) or agave (agave syrup).

Also useful are

synthetic, i.e. generally enzymatically produced starch or sugar hydrolysates (invert sugar, fructose syrup);
fruit concentrates (for example based on apples or pears);
sugar alcohols (for example erythritol, threitol, arabitol, ribotol, xylitol, sorbitol, mannitol, dulcitol, lactitol);
proteins (for example miraculin, monellin, thaumatin, curculin, brazzein);
sweeteners (for example MAGAP, sodium cyclamate, acesulfame K, neohesperidin dihydrochalcone, sodium saccharin, aspartame, superaspartame, neotame, alitame, sucralose, steviosides, rebaudiosides, lugduname, carrelame, sucrononates, sucrooctates, monatin, phenylodulcin);
sweet-tasting amino acids (for example glycine, D-leucine, D-threonine, D-asparagine, D-phenylalanine, D-tryptophan, L-proline);
further sweet-tasting, low molecular weight substances, for example hernandulcin, dihydrochalcone glycosides, glycyrrhizin, glycyrrhetic acid, derivatives and salts thereof, extracts of liquorice (Glycyrrhizza glabra ssp.), Lippia dulcis extracts, Momordica ssp. extracts or
individual substances such as, for example, Momordica grosvenori [Luo Han Guo] and the mogrosides obtained therefrom, Hydrangea dulcis or Stevia ssp. (e.g. Stevia rebaudiana) extracts.

Aroma/Flavour Compounds

The invention also permits, in particular, the use of aroma/flavour compounds having an ester, aldehyde or lactone structure which are particularly rapidly broken down in the presence of titanium dioxide and under the influence of light. The invention therefore also ensures improved stability, especially storage stability, of the aroma/flavour compounds.

The oral preparations according to the invention may comprise one or more aroma/flavour compounds. Typical examples include: acetophenone, allylcapronate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineole, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprinate, ethyl caproate, ethyl crotonate, ethylfuraneol, ethylguaiacol, ethyl isobutyrate, ethyl isovalerate, ethyl lactate, ethyl methylbutyrate, ethyl propionate, eucalyptol, eugenol, ethyl heptylate, 4-(p-hydroxyphenyl)-2-butanone, gamma-decalactone, geraniol, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerate, isobutyl butyrate, isobutyraldehyde, isoeugenol methyl ether, isopropyl methylthiazole, lauric acid, leavulic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methyl methyl butyrate, 2-methyl-2-pentenoic acid, methyl thiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-thiomenthanone, 4,4,2-thiomethylpentanone, thymol, delta-undecalactone, gamma-undecalactone, valencene, valeric acid, vanillin, acetoin, ethylvanillin, ethylvanillin isobutyrate(=3-ethoxy-4-isobutyryloxybenzaldehyde), 2,5-dimethyl-4-hydroxy-3(2H)-furanone and derivatives thereof (in this case preferably homofuraneol(=2-ethyl-4-hydroxy-5-methyl-3(2H)-furanone), homofuronol(=2-ethyl-5-methyl-4-hydroxy-3(2H)-furanone and 5-ethyl-2-methyl-4-hydroxy-3(2H)-furanone), maltol and maltol derivatives (in this case preferably ethylmaltol), coumarin and coumarin derivatives, gamma-lactones (in this case preferably gamma-undecalactone, gamma-nonalactone, gamma-decalactone), delta-lactones (in this case preferably 4-methyldeltadecalactone, massoia lactone, deltadecalactone, tuberolactone), methyl sorbate, divanillin, 4-hydroxy-2(or 5)-ethyl-5(or 2)-methyl-3(2H)-furanone, 2-hydroxy-3-methyl-2-cyclopentenone, 3-hydroxy-4,5-dimethyl-2(5H)-furanone, acetic acid isoamyl ester, butyric acid ethyl ester, butyric acid n-butyl ester, butyric acid isoamyl ester, 3-methylbutyric acid ethyl ester, n-hexanoic acid ethyl ester, n-hexanoic acid allyl ester, n-hexanoic acid n-butyl ester, n-octanoic acid ethyl ester, ethyl-3-methyl-3-phenyl glycidate, ethyl 2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl)disulfide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol and the stereoisomers, enantiomers, positional isomers, diastereomers, cis/trans-isomers and epimers of these substances (not cited explicitly here).

Vitamins

In a further embodiment of the present invention the food additives may comprise vitamins as a further optional group of added substances. Vitamins have myriad biochemical modes of action. Some act in a similar manner to hormones and regulate mineral metabolism (e.g. vitamin D), or act on the growth of cells and tissue and also cell differentiation (e.g. some forms of vitamin A). Others are antioxidants (e.g. vitamin E and, under certain circumstances, also vitamin C). The majority of vitamins (e.g. the B vitamins) are precursors for enzymatic cofactors, which assist enzymes in the catalysis of certain processes in metabolism. In this connection, vitamins may in some cases be closely bound to the enzymes, for example as part of the prosthetic group; an example hereof is biotin which is a part of the enzyme that is responsible for the structure of fatty acids. On the other hand vitamins may also be less strongly bound and then act as cocatalysts, for example as groups which may readily be eliminated and which transport chemical groups or electrons between the molecules. Thus, for example, folic acid transports methyl, formyl and methylene groups into the cell. Although its assistance in enzyme-substrate reactions is well known, its other properties are also of great importance to the body.

In the context of the present invention, useful vitamins include substances selected from the group consisting of
vitamin A (retinol, retinal, beta-carotene),
vitamin B1 (thiamin),
vitamin B2 (riboflavin),
vitamin B3 (niacin, niacinamide),
vitamin B5 (pantothenic acid),
vitamin B6 (pyridoxine, pyridoxamine and pyridoxal),
vitamin B7 (biotin),
vitamin B9 (folic acid, folinic acid),
vitamin B12 (cyanobalamin, hydroxycobalmin, methylcobalmin),
vitamin C (ascorbic acid),
vitamin D (cholecalciferol),
vitamin E (tocopherols, tocotrienols) and
vitamin K (phyllolquinone, menaquinone).

Preferred vitamins are the group of tocopherols as well as ascorbic acid.

Prebiotic Substances.

In a further preferred implementation of the invention the preparations may further comprise prebiotic substances (“prebiotics”) which form the group H. Prebiotics are defined as indigestible foodstuffs constituents, the provision of which stimulates the growth or the activity of a range of useful bacteria in the large intestine. The addition of prebiotic compounds improves the stability of anthocyanins toward decomposition processes in the intestinal tract. Various substances, in particular carbohydrates, particularly preferable as prebiotics in the context of the invention include, for instance, fructooligosaccharides, inulins, isomaltooligosaccharides, lactilol, lactosucrose, lactulose, pyrodextrins, soy oligosaccharides, transgalactooligosaccharides, xylooligosaccharides and beta-glucans.

Production Processes

Layering

Layering comprises first filling either component (a) or component (b) and subsequently charging the respective other component. This procedure may be repeated.

Swirl Dispensing

To generate a swirl pattern, filling of components (a) and (b) may be effected in two ways, namely by

(i) filling the two components (a) and (b) via separate fixed dispensing apparatuses into a container which rotates during the procedure, or by
(ii) filling the two components (a) and (b) either via a fixed dispensing apparatus and a rotating dispensing apparatus or via two synchronously rotating dispensing apparatuses into a container which remains fixed during the procedure.

Strand Dispensing

Strand dispensing comprises extrusion through coaxially arranged nozzles, i.e. component (a) is dispensed, for example, through the central, medially arranged nozzle and component (b) is dispensed through nozzles arranged concentrically around the central nozzle and generally having a markedly smaller diameter.

### INDUSTRIAL APPLICABILITY

The present invention further provides for the use of a preparation comprising

(a) a fresh cheese component and
(b) a fruit preparation,
wherein the components (a) and (b) are present side by side in a container such that they occupy three-dimensionally continuous volumes that do not mix, as a foodstuff, especially as a spread.

### EXAMPLES

### Quark Production Examples

The examples which follow are intended to highlight the advantage associated with the use of specific quark mixes using selected starter cultures.

### Examples 1 to 4, Comparative Examples C1 to C5

4 kg of skimmed milk were treated for 6 minutes at 88° C. and the proteins obtained were denatured. The mix was admixed with different lactic acid bacteria and rennet, matured for about 18 h at 30° C. and subsequently agitated. The fermentation product was then passed into a centrifuge and about 3.2 kg of acid whey liquid constituent was removed. The remaining quark mix (about 800 g) was adjusted to a dry matter content of 18 wt % and a protein content of 12 wt % by addition of cream. Example 4 differs from example 2 in that the base mix was additionally stirred (stretched) in a rotor-stator mixer from YTRON after fermentation. The products were subsequently subjected to taste and sensory evaluation on a scale of 1(=does not apply) to 6(=applies fully) by a panel consisting of 5 experienced testers. The results are summarized in table 1. Examples 1 to 4 are inventive while examples C1 to C5 are comparative. The average values for the evaluations are reported.

TABLE 1
Taste and sensory evaluation of the quark base mixes

| | | Taste | Sensory quality | | |
|---|---|---|---|---|---|
| Ex. | Starter culture | Bitter | Creamy | Smooth | Slimy |
| C1 | Bifidobacterium | 5.5 | 3.0 | 2.0 | 5.5 |
| | lactis B12 | | | | |
| C2 | Lactobacillus | 5.0 | 3.5 | 2.0 | 5.5 |
| | acidophilus | | | | |
| C3 | Bifidobacterium | 5.0 | 3.0 | 2.0 | 5.5 |
| | lactis B12 + | | | | |
| | Lactobacillus | | | | |
| | acidophilus | | | | |
| | (1:1) | | | | |
| C4 | Mixture (i) | 3.0 | 2.5 | 2.0 | 4.0 |
| C5 | Mixture (i) | 4.0 | 2.0 | 2.0 | 4.0 |
| 1 | Mixture (i + ii) = | 2.0 | 4.0 | 3.5 | 2.0 |
| | 75:25 | | | | |
| 2 | Mixture (i + ii) = | 1.5 | 4.5 | 4.0 | 1.0 |
| | 50:50 | | | | |
| 3 | Mixture (i + ii) = | 2.5 | 4.0 | 3.5 | 1.5 |
| | 25:75 | | | | |
| 4 | Mixture (i + ii) = | 1.0 | 5.5 | 4.5 | 1.0 |
| | 50:50 | | | | |

The tests and comparative tests clearly show that the choice of starter cultures has a marked impact on the taste and sensory properties of the quark base mix. The quark base mix with the best properties, i.e. lowest bitterness, highest creaminess and leaving no slimy impression, was obtained with an inventive combination of culture mixtures (i) and (ii). Treatment in the Ytron mixer achieved further improvement in the sensory values.

### Examples 5 to 7, Comparative Examples C6 to C10

The examples which follow show the impact of a targeted introduction of stirring energy into the fermented quark base mix on the physicochemical behaviour thereof. Said examples evaluate the effect of the treatment on the propensity of the quark base mix to absorb water upon addition of fruit preparations thus resulting in taste dilution. To this end, inventive quark base mixes produced on the basis of different starter cultures were each coated with 25 wt % of a jam of strawberries and pineapple once before and once after treatment with a YTRON rotor-stator mixer (20° C., 15 min, 2500 RPM) and both appearance impression and taste impression were evaluated by a panel of five experienced testers after storage of the preparations for a period of 5 hours at 7° C.

Evaluation of appearance was carried out with reference to a scale of from (1)=clear separation between quark mix and fruit preparation to (4)=quark mix and fruit preparation mixed; evaluation of taste was carried out in similar fashion on a scale of (1)=pronounced fruit taste to (4)=watery taste. The results are summarized in table 2 which follows. Examples 5 to 7 are inventive while examples C6 to C10 are comparative.

TABLE 2
Evaluation of the quark base mixes with and without
after treatment with a rotor-stator mixer

| | | Appearance | | Taste | |
|---|---|---|---|---|---|
| | | impression | | impression | |
| Ex. | Starter culture | Without | With | Without | With |
| C6 | Bifidobacterium | 3.5 | 3.0 | 3.0 | 2.5 |
| | lactis B12 | | | | |
| C7 | Lactobacillus | 3.5 | 3.0 | 3.0 | 3.0 |
| | acidophilus | | | | |
| C8 | Bifidobacterium | 3.5 | 3.0 | 3.0 | 2.5 |
| | lactis B12 + | | | | |
| | Lactobacillus | | | | |
| | acidophilus | | | | |
| | (1:1) | | | | |
| C9 | Mixture (i) | 3.0 | 3.0 | 3.0 | 2.5 |
| C10 | Mixture (i) | 3.0 | 2.5 | 3.0 | 2.5 |
| 5 | Mixture (i + ii) = | 2.0 | 1.0 | 2.0 | 1.0 |
| | 75:25 | | | | |
| 6 | Mixture (i + ii) = | 1.5 | 1.0 | 1.5 | 1.0 |
| | 50:50 | | | | |
| 7 | Mixture (i + ii) = | 2.0 | 1.0 | 2.0 | 1.0 |
| | 25:75 | | | | |

The examples and comparative examples show that aftertreatment in the rotor-stator mixer consistently results in a further improvement in both appearance impression and taste impression. The use of the selected culture mixtures as opposed to the standard product bifidobacterium in turn results in a markedly improved end product.

### End Product Production Examples

### Examples H1 to H6

Preparations according to table 3 were produced. Mixtures 1 to 4 were filled via a first static dispenser for component (a) and a second static dispenser for component (b) into a vessel rotating at 30 RPM. Mixtures 5 and 6 were extruded into the receiver via coaxial nozzles, specifically component (a) was extruded through a nozzle having a diameter of 0.5 cm and component (b) was extruded through five nozzles arranged concentrically around the main nozzle and having a diameter of 0.3 cm.

TABLE 3
Composition of the finished products

| Comp. | Constituent | H1 | H2 | H3 | H4 | H5 | H6 |
|---|---|---|---|---|---|---|---|
| A | Regular | 50 | 60 | 65 | 70 | 75 | 80 |
| | quark 15% | | | | | | |
| | FiDr* | | | | | | |
| B | Strawberry | 50 | — | — | — | 25 | — |
| | jam | | | | | | |
| | Cherry jam | — | 40 | — | — | — | 20 |
| | Blackberry | — | — | 35 | — | — | — |
| | jam | | | | | | |
| | Blackurrant | — | — | — | 30 | — | — |
| | jam | | | | | | |
| | Pectin | — | — | — | — | — | 0.2 |
| | Citric acid | 0.1 | 0.1 | 0.1 | 0.1 | 0.1 | 0.1 |

*Fat in dry matter; as per mixture 1 in table 1

1. A spreadable foodstuffs preparation comprising
(a) a fresh cheese component obtained by a process comprising the following steps:
(a1) subjecting the raw milk to heat treatment and removing the cream to obtain an un-acidified quark base mix,
(a2) subjecting the thus obtained mixture to heat treatment until onset of denaturation,
(a3) admixing the denatured product with starter cultures and rennet and optionally
(a4) adjusting the quark base mix obtained after completion of fermentation to a defined dry matter content and protein content,
where the starter cultures employed are
(i) a first mixture of five microorganism strains comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris and
(ii) a second mixture of three microorganism strains comprising (ii-1) Streptococcus thermophilus, (ii-2) Lactococcus lactis subsp. lactis and (ii-3) Lactococcus lactis subsp. Cremoris, and
(b) a fruit preparation,
wherein the components (a) and (b) are present side by side in a container such that they occupy three-dimensionally continuous volumes that do not mix.

2. The preparation according to claim 1, wherein the components (a) and (b) are layered.

3. The preparation according to claim 1, wherein the components (a) and (b) form a swirl pattern in the container.

4. The preparation according to claim 1, wherein the components (a) and (b) are present in the container as respective separate strands.

5. The preparation according to claim 1, comprising regular quark as component (a).

6. The preparation according to claim 1, comprising jam, fruit spread, confiture or fruit jelly as component (b).

7. The preparation according to claim 1, comprising components (a) and (b) in a weight ratio of about 80:20 to about 50:50.

8. The preparation according to claim 1, further comprising thickeners.

9. The preparation according to claim 1, further comprising acidulants and/or acidity regulators.

10. The preparation according to claim 1, comprising
(a) 20 to 80 wt % of fresh cheese,
(b) 20 to 50 wt % of fruit preparation,
(c) 0 to 5 wt % of thickeners,
(d) 0 to 2 wt % of acidulants and
(e) 0 to about 3 wt % of further auxiliary/added substances,
with the proviso that the specified amounts sum to 100 wt %.

11. A process for producing a spreadable foodstuffs preparation according to claim 1, comprising filling the two components (a) and (b) via separate fixed dispensing apparatuses into a container which rotates during the procedure.

12. A process for producing a spreadable foodstuffs preparation according to claim 1, comprising filling the two components (a) and (b) either via a fixed dispensing apparatus and a rotating dispensing apparatus or via two synchronously rotating dispensing apparatuses into a container which remains fixed during the procedure.

13. A process for producing a spreadable foodstuffs preparation according to claim 1, comprising extruding one component via a central, medially arranged nozzle and the other component through nozzles arranged concentrically around the central nozzle, into a container.

14. A method of using as a foodstuff a preparation comprising
(a) a fresh cheese component and
(b) a fruit preparation,
said method comprising presenting the components (a) and (b) side by side in a container such that they occupy three-dimensionally continuous volumes that do not mix.

15. The method according to claim 14, wherein the preparation is employed as a spread.
